(19) United States
(12) Patent Application Publication
(10) Pub. No.: US 2024/0403138 A1
(43) Pub. Date: Dec. 5, 2024

(54) Systems and Methods for Efficient Data Preprocessing of Machine Learning Workloads

(71) Applicant: Snorkel AI, Inc., Redwood City, CA (US)

(72) Inventors: Karthikeyan Sabhanatarajan, San Francisco, CA (US); Hristijan Bogoevski, Seattle, WA (US); Manas Joglekar, Bellingham, WA (US); Gaurav Aggarwal, Mountain View, CA (US); Henry Ehrenberg, San Francisco, CA (US)

(21) Appl. No.: 18/678,821

(22) Filed: May 30, 2024

Related U.S. Application Data
(60) Provisional application No. 63/470,399, filed on Jun. 1, 2023.

(51) Int. Cl. G06F 9/50; G06N 7/01

(52) U.S. Cl. CPC G06F 9/5083; G06F 9/5061; G06N 7/01

(57) ABSTRACT

A system, platform, apparatus, and associated methods for more efficiently pre-processing data for use in training a machine learning model, or for processing data for input to a trained model. Embodiments enable the dynamic allocation (or reallocation) of computational resources (e.g., processor cycles and/or memory) to the execution of a data pre-processing function or operation, and the reassignment of resources to a different data pre-processing function or operation as needed. This results in a more efficient approach to executing a set of pre-processing operations on data used to train a model or as input data for a trained model.

### CROSS REFERENCE TO RELATED APPLICATION

This application claims the benefit of U.S. Provisional Application No. 63/470,399, filed Jun. 1, 2023, entitled “Systems and Methods for Efficient Data Preprocessing of Machine Learning Workloads”, the disclosure of which is incorporated, in its entirety (including the Appendix) by this reference.

### BACKGROUND

Supervised machine learning (ML) is used widely across industries to derive insights from data and support automated decision systems. Supervised ML models are trained by applying an ML algorithm to a labeled training data set. Each data example (or element, in the form of variables, characteristics, parameters, or “features”) in the training data set is associated with a label (or annotation) that defines how the element should be classified by the trained model. A trained model can operate on a previously unseen data example to generate a predicted label or classification as an output (referred to as an inference).

For many situations in which a trained model is being used, the raw data input to the model may require pre-processing prior to the model operating on the data to generate a prediction or inference regarding the proper classification of the input data. Typically, the pre-processing involves a transformation or conversion of the input data from an initial table format (or other format, such as a collection of documents) into an appropriate table format (or other format, such as a collection of transformed or converted documents) for input to the trained model.

One or more pre-processors may be used to perform the transformation or set of transformations needed to prepare raw data for input to a trained model. However, there are typically dependencies between the pre-processing stages that make up a transformation or set of transformations. These can result in two types of problems: data imbalances between examples of input data¹ and differences in the computational requirements (e.g., the hardware profile and resources used) between different data pre-processors. The computational requirement problem arises from the (potentially) heterogeneous computing requirements of the different pre-processing stages, as different data processing stages or operations may require execution by different forms of processors. In this context, a heterogeneous computing system refers to a system that contains different types of computational units, such as one or more multicore CPUs, GPUs, DSPs, FPGAs, or ASICs, as non-limiting examples.

The disadvantages of conventional approaches to data pre-processing may be more important in workflows directed to the development of data or data sets, where such operations are expected to be performed more often as part of developing the data. Embodiments are directed to overcoming the disadvantages of conventional approaches to the pre-processing of data used to train a machine learning model or as an input to a machine learning model, either alone or in combination.

### SUMMARY

The terms “invention,” “the invention,” “this invention,” “the present invention,” “the present disclosure,” or “the disclosure” as used herein refer broadly to all subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The

¹ As an example, assume a PDF document is being preprocessed. A single document has 100 pages. Initially, the processing starts with one row that describes the document URL to extract. After the data goes through a PDF Processor, that stage outputs 100 rows, with one row for each page. This data goes through a filtering processor that is used to identify and remove blank pages. As an example, assume this document has 20 blank pages. Then the final filtered out data has 80 rows (or pages).

Now assume there is a second 100-page PDF document, and this document has 50 blank pages. This is part of a second partition. After the filtering operation to remove blank pages, there will be 50 rows (or pages). Thus, a first partition has 80 pages, and a second partition has 50 pages. This partition imbalance can create difficulties for some of the pre-processing stages because a stage may require data in a specific format.

subject matter should be understood by reference to appropriate portions of the entire specification, to any or all figures or drawings, and to each claim.

In the context of this disclosure, a classifier is a model or algorithm that is used to predict labels or groups of labels for data, or for subcomponents of data. A classifier may be used to classify whether data is a member of one or more categories or groups (e.g., a text document or an image), whether and where certain entities or objects are present in data (e.g., detecting and tagging objects in images, or specific entities in text), or might be used to rank data on a real-valued scale, as non-limiting examples.

In general, a classifier may be used to assign an identifying label to a set of input data, where the label may represent a class or category. In one use case, a classifier may be used to determine an expected or “predicted” output based on a set of input data. Classifiers are often used in the processing of data sets and may be implemented in the form of trained machine learning (ML) models, deep learning (DL) models, or neural networks. As mentioned, training a model requires a set of data items and an associated label or annotation for each data item. The associated label or annotation may be provided by a source of ground-truth data (such as a subject matter expert), a programmatic labeling process, or other suitable technique.

Embodiments of the disclosed systems, apparatuses, and methods introduce an approach to pre-processing a set of data for use in training a model or for use as an input to a trained model. Among other aspects, embodiments efficiently and dynamically provision the hardware resources used for the pre-processing of such data sets. Embodiments provide a solution to the problems encountered by conventional approaches related to data imbalances and heterogeneous computing requirements in the pre-processing of machine learning model data sets. Embodiments also provide an efficient process flow for preparing such data sets for use in training a model or for performing an inference process on a data set using a trained model. In some cases, the pre-processing may add rows or columns, remove rows or columns of a table, or modify an existing cell or cells of a table. If the format is a collection of documents, in some cases, the pre-processing may modify the contents of (or metadata associated with) the documents.

In one embodiment, the disclosure is directed to a method for pre-processing a set of data for use in training a machine learning or other form of model or for use as an input to a trained model. The method may include the following steps, stages, functions, processes, or operations:
Represent the pre-processing of a data set as a sequence of data conversion and/or transformation operations:
   Each operation in the sequence may be associated with specific dependencies (such as a data format output by one stage and used as an input to a next stage);
Represent the sequence of data conversions and/or transformations and dependencies as a directed acyclic graph (DAG) formed from operations/nodes and connecting edges;
   A DAG can be used to represent an ordered sequence of operations that do not result in returning to a previous state;
      This represents the pre-processing of a data set as a time-ordered sequence of operations or functions;
Separate the DAG into a set of sub-graphs based on the hardware requirements of a processing step or stage represented by an edge (for example, if it requires a GPU if it is using a deep learning Transformer (Natural Language Processing) model);
   A process may be used to break a DAG into sub-graphs where the output of one node is input to many nodes (referred to as “scatter”) and/or the input of one node depends on the output of many nodes (referred to as “gather”);
   The disclosed method then identifies nodes representing operations by their hardware requirements (for example, ones that require a GPU, or where the hardware execution requirement of a node changes from CPU to GPU, or vice-versa);
      In some embodiments, this process of identifying the hardware requirements of operations/nodes may be performed by one or more of a priori knowledge (such as static analysis and/or operator heuristics) and posteriori knowledge (such as obtained by a sampling technique);
   The DAG is then separated into sub-graphs, with each sub-graph representing a CPU or GPU intensive set of operations (i.e., a set of operations executed by a specific type or category of processor), and the corresponding input and output data from that set of operations;
Rebalance the partitions (i.e., a portion or subset of the dataset, such as a subset of rows or documents) in the data sets input to, or output by, an operation (or set of operations in a sub-graph) to have the same size after each operation or set of operations (referred to as “dynamic re-partitioning” herein);
   In one embodiment, this re-partitioning is implemented prior to performing the operations associated with a sub-graph, and is executed on the data output by a previous sub-graph;
      As part of the re-partitioning, data from a sampling may be used to determine the actual size of a partition. For example, instead of dividing the number of rows among the available hardware cores, a sampler may be executed to identify what the partition size should be. The sampler may take samples of the input partitions and execute the sub-graph on them in order to estimate the size of the output partition;
Each sub-graph (and its associated functions or operations) may then be associated with a set of pre-execution stages, one or more of which may be performed:
   Data sampling (to determine the hardware resource requirements, e.g., CPU, GPU, and associated memory);
      Each processor “indicates” its desired hardware profile (CPU, GPU, or FPGA, as examples);
         In some situations, a processor can explicitly indicate a preferred hardware profile. Further, as mentioned, a sampling process can be used to determine a suitable hardware profile for a sub-graph;
      In one embodiment, a sampling mechanism is used to determine the memory requirement of the operations or functions associated with a sub-graph;
      At the conclusion of the sampling mechanism, two parameters are known:
         The execution time for the sampled data;
         If the execution time of the sampled data can be improved with a different hardware profile, then this information may be used to automatically change a sub-graph to a different hardware profile (i.e., GPU), even if an explicit specification for such a processor type is absent; and
         The amount of memory used to process the sampled data, as represented by the data processing operations of the sub-graph;
   Next, interpolate/extrapolate the execution time and memory derived from the sampled data to the entire set of data (e.g., for the number of rows in a partition). This gives the estimated memory requirement and execution time for the rows in the partition using the operations represented in the sub-graph;
      Dynamically reduce the partition size if the memory requirement is too high to be executed by a single processor or device, or if this would result in an undesirable allocation of memory to a specific processor (for example, if memory limits are reached during processing, divide the partition in two (and repeat if necessary) until execution completes successfully);
If needed, perform additional data rebalancing—for example, dynamic repartitioning to ensure all partitions have the same number of rows;
These steps or stages are followed by execution/traversal of the sub-graph with the rebalanced data using one or more hardware profiles as indicated by the sub-graph, i.e., based on the hardware configuration requirement (processor type and memory requirement) for each “stage” or operation of the data processing described by a sub-graph.

As described, the data processing operations represented by a DAG may involve two primary categories of operations-computational and data. The computational category involves performing a static analysis of an operator that is part of the DAG and sampling to determine how to break a graph into sub-graph(s). The data category involves using sampling to determine the “correct” or more optimal partition size for the data.

In one embodiment, the disclosure is directed to a system for more efficiently pre-processing data for use in training a machine learning model, or for processing data for input to a trained model. The system may include a set of computer-executable instructions, a memory or data storage element (such as a non-transitory computer-readable medium) in (or on) which the instructions are stored, and an electronic processor or co-processors. When executed by the processor or co-processors, the instructions cause the processor or co-processors (or an apparatus or device of which they are part) to perform a set of operations that implement an embodiment of the disclosed method or methods.

In one embodiment, the disclosure is directed to one or more non-transitory computer-readable media (e.g., a data storage element) containing a set of computer-executable instructions, wherein when the set of instructions are executed by an electronic processor or co-processors, the processor or co-processors (or an apparatus or device of which they are part) perform a set of operations that implement an embodiment of the disclosed method or methods.

In some embodiments, the systems and methods disclosed herein may provide services through a SaaS or multi-tenant platform. The platform provides access to multiple entities, each with a separate account and associated data storage. Each account may correspond to a user, an entity, a set or category of entities, a set or category of users, a set or category of data, a specific model being trained or a specific trained model, a set of operations or functions being performed, an industry, or an organization, as examples. Each account may access one or more services, a set of which are instantiated in their account, and which implement one or more of the methods or functions disclosed and/or described herein.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in detail herein. However, embodiments of the disclosure are not limited to the specific examples or forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1 is a flowchart or flow diagram illustrating a method, process, or set of steps, stages, functions, or operations for pre-processing data for use in training a machine learning model, or processing data for input to a trained model, in accordance with some embodiments;

FIG. 2 is a diagram illustrating elements or components that may be present in a computing device, server, or system configured to implement a method, process, function, or operation in accordance with some embodiments; and

FIGS. 3, 4, and 5 are diagrams illustrating an architecture for a multi-tenant or Saas platform that may be used in implementing an embodiment of the systems, apparatuses, and methods disclosed herein.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter are described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that this disclosure will satisfy the statutory requirements and convey the scope of the disclosure to those skilled in the art.

Among other forms, the subject matter of the disclosure may be embodied in whole or in part as a system, as one or more methods, or as one or more devices or apparatuses. Embodiments may take the form of a hardware implemented embodiment, a software implemented embodiment, or an embodiment combining software and hardware aspects. For example, in some embodiments, one or more of the operations, functions, processes, or methods described herein may be implemented by a suitable processing element or elements (such as a processor, microprocessor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements (such as one or more computer-readable media). In some embodiments, the set of instructions may be conveyed to a user over a network (e.g., the Internet) through a transfer of instructions or an application that executes a set of instructions.

In some embodiments, the systems and methods disclosed herein may provide services through a SaaS or multi-tenant platform. The platform provides access to multiple entities, each with a separate account and associated data storage. Each account may correspond to a user, an entity, a set or category of entities, a set or category of users, a set or category of data, a specific model being trained or a specific trained model, a set of operations or functions being performed, an industry, or an organization, for example. Each account may access one or more services, a set of which are instantiated in their account, and which implement one or more of the methods or functions disclosed and/or described herein.

In some embodiments, one or more of the operations, functions, processes, or methods disclosed and/or described herein may be implemented by a specialized form of hardware, such as a programmable gate array, application specific integrated circuit (ASIC), or the like. Note that an embodiment may be implemented in the form of an application, a sub-routine that is part of a larger application, a “plug-in”, an extension to the functionality of a data processing system or platform, or other suitable form. The following detailed description is, therefore, not to be taken in a limiting sense.

Embodiments are directed to a system, platform, apparatus, and associated methods for more efficiently pre-processing data for use in training a machine learning model, or for processing data for input to a trained model. Embodiments enable the dynamic allocation (or reallocation) of computational resources (e.g., processor cycles and/or memory) to the execution of a data pre-processing function or operation, and the reassignment of resources to a different data pre-processing function or operation as needed. This results in a more efficient approach to executing a set of pre-processing operations on data used to train a model or as input data for a trained model.

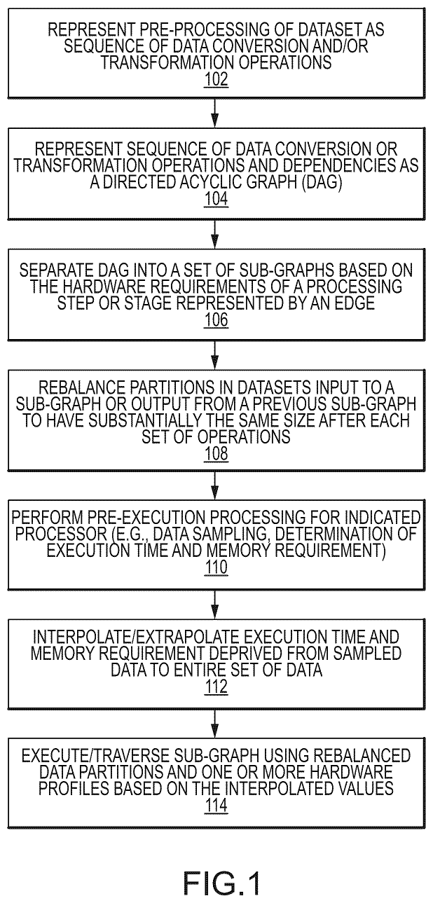

FIG. 1 is a flowchart or flow diagram illustrating a method, process, or set of steps, stages, functions, or operations for pre-processing data for use in training a machine learning model, or for processing data for input to a trained model, in accordance with some embodiments. As shown in the figure, the method, process, or set of steps, stages, functions, or operations may include one or more of the following:
Represent the pre-processing of a data set prior to its use as a sequence of data conversion and/or transformation operations (as suggested by step or stage 102):
   In some embodiments, this may include separating a data pre-processing flow into a sequence of defined operations or functions;
      For example, the operations might include executing an optical character recognition model on a PDF document to extract the text content, sanitizing raw text fields to remove unexpected characters, or executing a machine learning model on text data to compute an embedding representation;
   Each operation or function in the sequence may be associated with specific dependencies (such as a data format output by one stage and used as an input to a next stage);
      For example, data may be contained in a table with a specific number of rows and columns, or associated with a format for specific fields or values;
Represent the sequence of data conversions and/or transformations and dependencies as a directed acyclic graph (DAG)² formed from operations/nodes and connecting edges representing the resource (such as the processor category) used to perform that operation or function (as suggested by step or stage 104);

² A set of vertices (nodes) and edges (arcs), with each edge directed (traversed in a specified direction) from one vertex to another, such that following those directions will never form a closed loop.
A DAG may be considered a form of finite state machine where each node represents an allowed state and transitions between states are determined by rules or operations that define edges of the DAG structure (such as the type or category of processor element used);
   Thus, a DAG can be used to represent an ordered sequence of data processing functions or operations that do not result in returning to a previous state;
Separate the DAG into a set of sub-graphs based on the hardware requirements of a processing step or stage represented by an edge (for example, if it requires a GPU if it is using a deep learning Transformer (Natural Language Processing) model) (as suggested by step or stage 106);
   If another form or category of processing component is used, perform the same separation process to identify sub-graphs representing an operation or operations performed by that processing component;
   In one embodiment, a process may be used to break a DAG into a set of sub-graphs, such as where the output of one node is input to many nodes (e.g., referred to as “scatter”) and/or the input of one node depends on output of many nodes (referred to as “gather”);
   The disclosed method then identifies nodes representing operations by their hardware requirements (for example, ones that require a GPU, or where the hardware execution requirement of a node changes from CPU to GPU, or vice-versa);
      This identification may be based on the type of data processing operations or functions performed by a node (e.g., image processing or a mathematical transform on a matrix, as non-limiting examples);
      In some embodiments, this process of identifying the hardware requirements of operations/nodes may be performed by one or more of a priori knowledge (such as static analysis and/or operator heuristics) and posteriori knowledge (such as obtained by a sampling technique);
         As a non-limiting example, in one embodiment, after identification of the separation points of a DAG into sub-graphs by MapReduce (or another technique), a static analysis of the operators may be performed and used to create further sub-graphs. The static analysis may include using information about an operator, such as if it is a known CPU intensive/dependent operator (e.g., PDFProcessor), or a Deep Learning model. For custom operators, a user can specify a Boolean flag (i.e., the operator or function is “expensive”) as a costing hint;
      Sampling may be used to refine the generated sub-graphs to obtain a set of final sub-graphs or stages. For example, a static analysis evaluation may indicate 3 sub-graphs. However, if during sampling it is determined that Stage 2 is relatively “expensive”, then it may be further divided into a Stage 2.1 sub-graph and a Stage 2.2 sub-graph;
   As mentioned, the DAG or one or more of the identified sub-graphs may be further separated into sub-graphs, with each sub-graph representing a CPU or GPU intensive set of operations (i.e., a set of operations executed by a specific type or category of processor), and the corresponding input and output data from that set of operations;
Rebalance the partitions in the data sets input or output by a set of operations (i.e., input to a sub-graph or output from a previous sub-graph) to have the same size (i.e., the same number of rows and columns in a table, as an example) after each set of operations (referred to as “dynamic re-partitioning” herein) (as suggested by step or stage 108);
   In one embodiment, this re-partitioning is implemented prior to performing the operations associated with a sub-graph, and is executed on the data output by a previous sub-graph in a sequence of sub-graphs/operations;
      As part of the re-partitioning, data from a sampling operation may be used to determine the size of a partition. For example, instead of dividing the number of rows among the available hardware (processor) cores, a sampler may be executed to identify a more optimal partition size. The sampler may take samples of the input partitions and execute the sub-graph on them in order to estimate the size of the output partition;
Each sub-graph (and its associated functions or operations) may then be associated with a set of pre-execution stages/operations to address the use of heterogeneous computing resources in executing the operations or functions of the DAG or sub-graph, and to do so more efficiently than conventional approaches (as suggested by step or stage 110). In one embodiment, these pre-execution stages may include one or more of:
   Data sampling (to determine the hardware resource requirements, e.g., processor type (CPU/GPU) and associated memory);
      Each processor “indicates” or is associated with a desired hardware profile (CPU, GPU, or FPGA, as non-limiting examples);
         In some situations, a processor can explicitly indicate a preferred hardware profile. Further, as mentioned, a sampling process can be used to determine a suitable hardware profile for a sub-graph;
      In one embodiment, a sampling mechanism is used to determine the memory requirement of the operations or functions associated with a sub-graph;
         As an example of an approach to addressing heterogeneous computing requirements, take 25-50 rows of the data. Pass this data through the sub-graph (i.e., use it as an input to the data processing stages or operations represented by the sub-graph);
         Start with a baseline memory requirement prior to execution of the data sampling process. Execute the sampling process by passing the sampled data through the sub-graph. While doing so, periodically monitor the memory usage of the sampling process, and record the peak memory use;
      At the conclusion of the sampling mechanism, two parameters are known:
         The execution time for the sampled data;
         If the execution time of the sampled data can be improved with a different hardware profile, then this information may be used to automatically change a sub-graph to a different hardware profile (i.e., GPU), even if an explicit specification for such a processor type is absent; and
         The (peak) memory used to process the sampled data, as represented by the data processing operations of the sub-graph;
   Next, interpolate/extrapolate the execution time and memory derived from the sampled data to the entire set of data (e.g., for the number of rows in a partition) (as suggested by step or stage 112). This gives the estimated memory requirement and execution time for the rows in the partition using the operations represented in the sub-graph;
      This may include dynamically reducing the partition size if the memory requirement is too high to be executed by a single processor or device, or if this would result in an undesirable allocation of memory to a specific processor;
         For example, iteratively reduce the size of a partition, perform a resampling and determination of the memory requirement, and continue as needed;
   If needed, perform additional data rebalancing—for example, apply dynamic repartitioning to ensure all partitions have the same number of rows (or other relevant characteristic);
These steps or stages are followed by execution/traversal of the sub-graph with the rebalanced data using one or more hardware profiles, as determined by the hardware configuration requirement(s) for each “stage”, function, or operation of the data processing described by a sub-graph (i.e., the interpolated values for the processor type, computation time, and memory requirement) (as suggested by step or stage 114). This allows the process flow to:
   Dynamically access and use the needed/desired hardware resources and make them accessible to other processes once the processing is complete for a sub-graph. This provides a benefit of cost savings by limiting the use of the relatively expensive resources (in terms of computational time or memory) to when they are needed for implementing a stage, function, or operation of a sub-graph;
      In contrast, a conventional approach maintains access to resources for the entire execution of the DAG. This increases the processing cost and prevents a resource from being available for use by another operation or function;
   Efficiently interleave different workloads on the same hardware profile (i.e., using the same resource);
      In contrast, conventional implementations can monopolize computational resources for the entire execution time of a sub-graph, thus preventing their most efficient usage and possibly delaying the execution of a portion of a different sub-graph.

In a general sense, the dependencies, data conversions, and/or transformations referred to herein relate to characteristics and ordering of data processing operations performed on data used for training or input to a trained ML model. The dependencies may arise from the order or sequencing of operations, such as where a processing stage needs to be performed prior to providing the output to a subsequent stage. Typically, basic types of operators (such as raw input sanitization or basic document/language structure parsers) are executed first, then more specialized operators that might or might not be relevant depending on the application (such as detecting tables in a PDF document, or computing an embedding for raw text or an image), followed by application-specific operators (such as one analyzing a specific piece of information from a table in a PDF document).

For example, if one is trying to find the oldest person in a census table in a PDF document, the process flow first needs to perform basic PDF parsing, then find and parse the table structure in the PDF, then find the values in the age column of the table, then find the largest value. However, this structure might vary significantly and can also branch in the case of a more complex processing flow or set of operations (hence the more general DAG structure is used in embodiments, instead of a linear chain of operations).

Among others, novel aspects of the disclosed approach include the dynamic partition and subgraph sizing, and the subgraph definition to accommodate heterogenous hardware needs. These functions and operations are important in ML pipeline settings, as ML-based operators may require GPU processing and may have impacts on performance and output partition characteristics.

In contrast, most “model-centric” ML approaches/systems/processes treat training data (and therefore the steps leading to its creation) as largely static (other than use of a surface-level process such as feature engineering). The disclosed and/or described approach is expected to be more impactful for data-centric systems, where a process flow might be updating (and re-executing) dataset pre-processing steps frequently as part of development or an iteration and incorporates stages to iterate training data to process it more efficiently and effectively.

This includes use of upstream preprocessing steps such as those that might be used to generate representations of the data to feed into an ML model, or those that might be used to create attributes/representations for users of programmatic labeling or data curation. A resulting benefit is more efficient use of computational resources, as well as lower latency for users when updating the training dataset (for example by updating pre-processors).

In some embodiments, the pre-processing stages include the disclosed and/or described dynamic partitioning and subgraph sizing operations, and the subgraph definition (as being processor dependent). As mentioned, a valuable use of the disclosed approach is as part of a programmatic labeling or data curation pipeline to prepare data for training a model. Programmatic labeling or data curation may involve frequent re-computation (re-execution) of one or more processing pipelines, so performance and reliability are important considerations and are improved by use of the disclosed and/or described techniques.

As a non-limiting example, consider a document intelligence application where each input document in the form of a PDF is parsed for content and structure, then run through a deep learning table detection model, then has pages without tables filtered out, and then has numeric values from each table extracted. In this example, a possible representation of the DAG for this application and its associated operations or functions (with hardware requirements and approximate processing time for 100 documents) is a workflow of the following form:
PDFProcessing (CPU) (10 mins)→DeepLearningTableDetection (GPU) (20 mins)→FilterNonTablePages (CPU) (3 mins)→NumericExtraction (CPU) (3 mins) Where this set of operations is executed for each of 100 documents.

In a conventional workflow, this set of operations would use 4 nodes performing the Table detection operation with a GPU, with each node executing the above sequence of data processing operations for 25 documents. The total time for execution of this set of operations is estimated to be 36 minutes on a conventional processing apparatus (e.g., Spark, as an example).

In contrast, using an embodiment of the disclosed system and methods, the overall process flow may be broken into 3 sub-graphs:
Sub-graph 1: PDFProcessing (10 mins)
Sub-graph 2: DeepLearningTableDetection (GPU)
Sub-graph 3: FilterNonTablePages (CPU) (3 mins)→NumericExtraction (CPU) (3 mins)

The expected processing flow is then:
Start with 4 CPU instances and execute Sub-graph 1;
Stop the CPU instances and start 4 GPU instances to execute Sub-graph 2; and
Shutdown the GPU instances and activate (un-pause) the CPU instances to execute Sub-graph 3.

In this proposed configuration and processing flow, the total “cost” in terms of processor execution time may be estimated to be:
CPU instances: 16 mins
GPU instances: 20 mins, where

GPU instances ($1/min) are relatively expensive compared to CPU instances (10 cents/min).

Based on these estimated prices for GPU vs. CPU computation time, the “cost” using the original method is $36. In contrast, the “cost” when using the disclosed approach is $21.6 (20*1$+16*10 cents), and therefore a not insignificant savings.

As a further example, consider an image processing application. In this example:
An input image is resized and input to a pre-trained deep learning object detection model; each detected object is embedded, and the image is (optionally) filtered out (removed from further processing) depending on the embeddings of the detected objects, followed by generating a thumbnail image corresponding to the input image if it is not filtered out;
   Expressed as a DAG representation, this set of operations or functions becomes: ResizeOriginallmage (CPU) (10 mins)→DeepLearningObjectDetection (GPU) (20 mins)→EmbeddingsGeneration (GPU) (10 mins)→EmbeddingBasedImageFiltering (GPU) (2 mins)→ImageThumbnailGeneration (CPU).

As yet another example, consider a conversational intelligence application. In this example:
An input audio recording of a conversation (or a segment of one) is converted to a text transcription (e.g., using a speech-to-text technique) and input to a deep learning entity detection model. Some or all of the detected/identified/classified entities are optionally filtered out, and the remaining entities are looked up in a knowledgebase if they are not filtered out;
   Expressed as a DAG representation: SpeechToTextConversion (CPU) (10 mins)→DeepLearningEntityDetection (GPU) (10 mins)→EntityFilter (CPU) (4 mins)→EntityLookup (CPU) (4 mins).

In the above examples, a sequence of data processing steps or stages are converted to a representation as a DAG, which may then be subjected to the processing flow disclosed and/or described herein to determine a more optimal (less computationally costly) execution order and process flow or path.

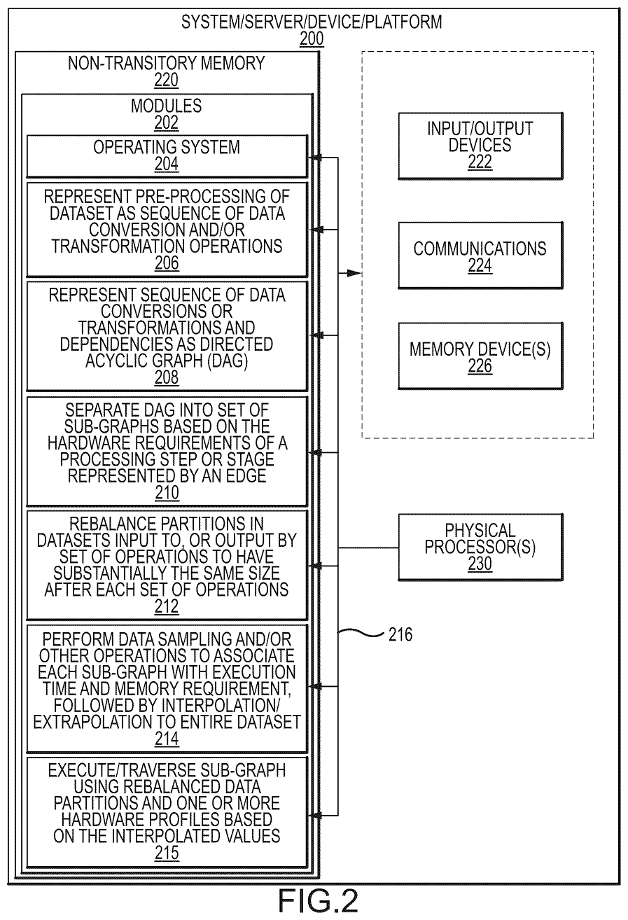

FIG. 2 is a diagram illustrating elements, components, operations, functions, or processes that may be present in or executed by one or more of a computing device, server, platform, or system 200 configured to implement a method, process, function, or operation in accordance with some embodiments. In some embodiments, the disclosed and/or described system and methods may be implemented in the form of an apparatus or apparatuses (such as a server that is part of a system or platform, or a client device) that includes a processing element and a set of executable instructions. The executable instructions may be part of a software application (or applications) and arranged into a software architecture.

In general, an embodiment may be implemented using a set of software instructions that are executed by a suitably programmed processing element (e.g., a GPU, CPU, TPU, QPU, microprocessor, processor, controller, state machine, or other computing device). In a complex application or system such instructions are typically arranged into “modules” and sub-modules with each such module or sub-module typically performing a specific task, process, function, or operation. The entire set of modules and sub-modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the disclosed and/or described systems, apparatuses, and methods.

The modules and/or sub-modules may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

A module or sub-module may contain instructions that are executed by a processor contained in more than one of a server, client device, network element, system, platform, or other component. Thus, in some embodiments, a plurality of electronic processors, with each being part of a separate device, server, platform, network element, or system may be responsible for executing all or a portion of the software instructions contained in an illustrated module or sub-module. Thus, although FIG. 2 illustrates a set of modules which taken together perform multiple functions, processes, or operations, these functions, processes, or operations may be performed by different devices, components, servers, or system elements, with certain of the modules or sub-modules (or instructions contained in those modules or sub-modules) being associated with and executed by those devices, components, servers, or system elements.

As shown in FIG. 2, system 200 may represent one or more of a system, server, client device, platform, or other form of computing or data processing device. Modules 202 each contain a set of executable instructions, where when the set of instructions is executed by a suitable electronic processor (such as that indicated in the figure by “Physical Processor(s) 230”), system (or platform, server, or device) 200 operates to perform a specific process, operation, function, or method.

Modules 202 may contain one or more sets of instructions for performing a method or function described with reference to the Figures, and the disclosure and/or description of the functions and operations provided in the specification. The modules may include those illustrated but may also include a greater number or fewer number than those illustrated. Further, the modules and the set of computer-executable instructions that are contained in each of the modules may be executed (in whole or in part) by the same processor or by more than a single processor. If executed by more than a single processor, the other processors may be contained in different devices, for example a processor in a client device and a processor in a server.

Modules 202 are stored in a non-transitory memory 220, which typically includes an Operating System module 204 that contains instructions used (among other functions) to access and control the execution of the instructions contained in other modules or sub-modules. The modules 202 in memory 220 are accessed for purposes of transferring data and executing instructions by a “bus” or communications line 216, which also serves to permit processor(s) 230 to communicate with the modules for purposes of accessing and executing instructions. Bus or communications line 216 also permits processor(s) 230 to interact with other elements of system 200, such as input or output devices 222, communications elements 224 for exchanging data and information with devices external to system 200, and additional memory devices 226.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor, processors, or co-processors cause the processor(s) or co-processors (or a device, devices, system, systems, server, or servers in which they are contained) to perform the specific function, method, process, or operation. As mentioned, an apparatus or device in which a processor or co-processor is contained may be one or both of a client device or a remote server or platform. Therefore, a module may contain instructions that are executed (in whole or in part) by the client device, the server or platform, or both. Such function, method, process, or operation may include those used to implement one or more aspects of the disclosed and/or described system and methods, such as to:
Represent the pre-processing of a dataset as a sequence of data conversion and/or transformation operations (as suggested by module 206):
   In some embodiments, this may include separating a data pre-processing flow into a sequence of defined operations or functions;
   Each operation in the sequence may be associated with specific dependencies (such as a data format output by one stage and used as an input to a next stage);
Represent the sequence of data conversions and/or transformations and dependencies as a directed acyclic graph (DAG) (as suggested by module 208);
Separate the DAG into a set of sub-graphs based on the hardware requirements of a processing step or stage represented by an edge (for example, if it requires a GPU if it is using a deep learning model) (as suggested by module 210);
   The DAG or one or more of the identified sub-graphs may be further separated into sub-graphs, with each sub-graph representing a CPU or GPU intensive set of operations (i.e., a set of operations executed by a specific type or category of processor), and the corresponding input and output data from that set of operations;
   If other forms of processing components are used, perform the same separation process to identify sub-graphs representing an operation or operations performed by that processing component;
   In one embodiment, a process may be used to break a DAG into a set of sub-graphs, such as where the output of one node is input to many nodes (e.g., referred to as “scatter”) and/or the input of one node depends on output of many nodes (referred to as “gather”);
Rebalance (modify) the partitions in the datasets input to, or output by a set of operations to have the same size after each set of operations (referred to as “dynamic re-partitioning” herein);
   In one embodiment, this re-partitioning is implemented prior to performing the operations associated with a sub-graph, and is executed on the data output by a previous sub-graph;
   As a non-limiting example, this may involve causing data sets input or output by a set of operations (i.e., input to a sub-graph or output from a previous sub-graph) to have the same size (i.e., the same number of rows and columns in a table, as an example, although a different characteristic may be used) after each set of operations;
Each sub-graph (and its associated functions or operations) may then be associated with a set of pre-execution stages (as suggested by module 214). In one embodiment, these pre-execution stages may include one or more of:
   Data sampling (to determine the hardware resource requirements, e.g., CPU or GPU and memory);
      Each processor “indicates” or is associated with a desired hardware profile (CPU, GPU, or FPGA, as examples);
      In one embodiment, a sampling mechanism is used to determine the memory requirement for the operations or functions associated with a sub-graph;
      At the conclusion of the sampling mechanism, two parameters are known:
         The execution time for the sampled data; and
         The (peak) memory used to process the sampled data, as represented by the data processing operations of the sub-graph;
   Next, interpolate/extrapolate the execution time and memory derived from the sampled data to the entire set of data (e.g., the number of rows in the partition associated with the sub-graph). This gives the estimated memory requirement and time to execute the rows in the partition using the operations represented in the sub-graph;
   This may include dynamically reducing the partition size if the memory requirement is too high to be executed by a single processor or device, or is undesirable for another reason;
   If needed, perform additional data rebalancing—for example, apply dynamic repartitioning to ensure all partitions have the same number of rows (or other relevant characteristic;
These steps or stages are followed by execution/traversal of the sub-graph with the rebalanced data using one or more hardware profiles, as determined by the hardware configuration requirement for each “stage”, function, or operation of the data processing described by a sub-graph (i.e., the interpolated values for the processor type, computation time, and memory requirement) (as suggested by module 215).

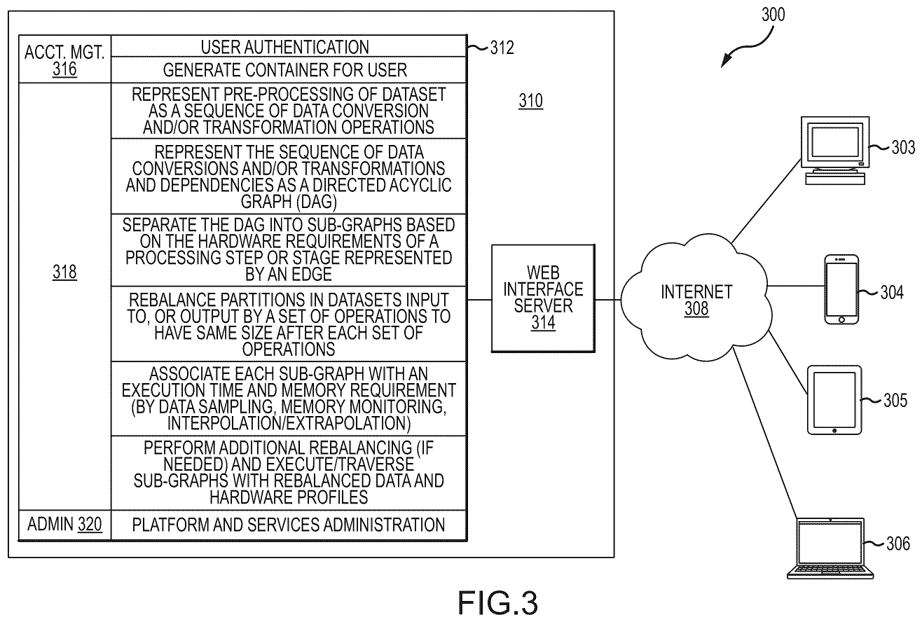

In some embodiments, the functionality and services provided by the system, apparatuses, and methods disclosed and/or described herein may be made available to multiple users by accessing an account maintained by a server or service platform. Such a server or service platform may be termed a form of Software-as-a-Service (Saas). FIGS. 3, 4, and 5 are diagrams illustrating an architecture for a multi-tenant or SaaS platform that may be used in implementing an embodiment of the systems, apparatuses, and methods disclosed and/or described herein.

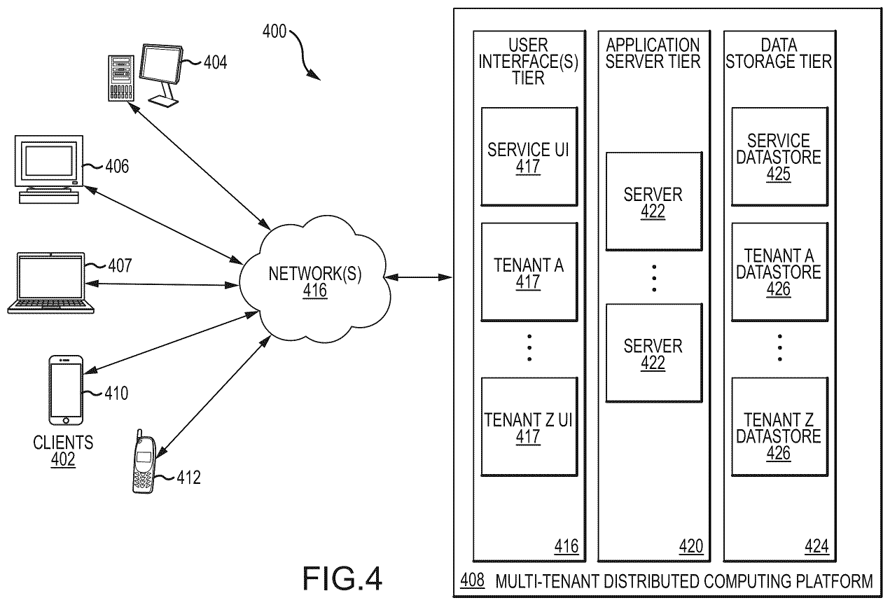

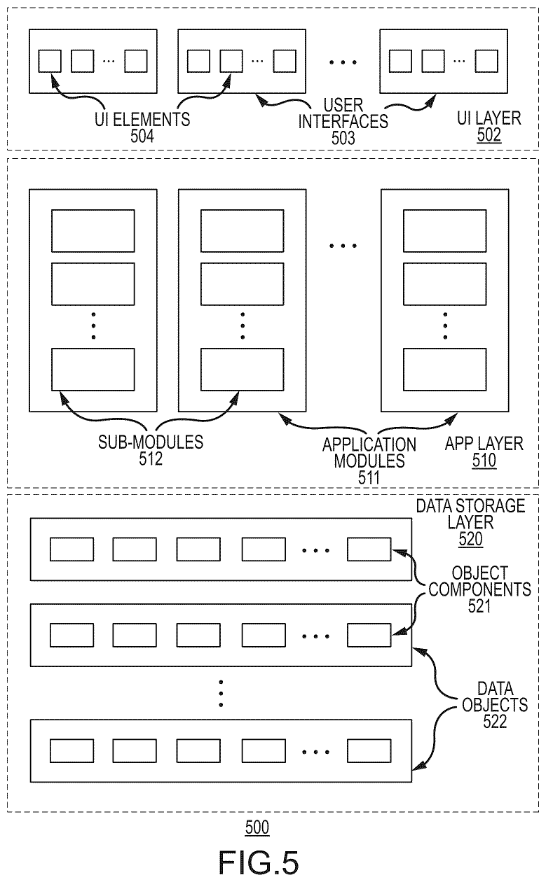

FIG. 3 is a diagram illustrating a SaaS system with which an embodiment may be implemented. FIG. 4 is a diagram illustrating elements or components of an example operating environment with which an embodiment may be implemented. FIG. 5 is a diagram illustrating additional details of the elements or components of the multi-tenant distributed computing service platform of FIG. 4, with which an embodiment may be implemented.

In some embodiments, the system or services disclosed and/or described herein may be implemented as microservices, processes, workflows or functions performed in response to the submission of a set of input data or a request. The microservices, processes, workflows or functions may be performed by a server, data processing element, platform, or system. In some embodiments, data analysis, data processing, and other services may be provided by a service platform located “in the cloud”. In such embodiments, the platform may be accessible through APIs and SDKs.

The functions, processes and capabilities disclosed herein and described with reference to one or more of the Figures may be provided as microservices within a platform. The interfaces to the microservices may be defined by REST and GraphQL endpoints. An administrative console may allow users or an administrator to securely access the underlying request and response data, manage accounts and access, and in some cases, modify the processing workflow or configuration.

Note that although FIGS. 3, 4, and 5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide one or more of the processes, functions, and operations disclosed and/or described herein. Although in some embodiments, a platform or system of the type illustrated in the Figures may be operated by a service provider to provide a specific set of services or applications, in other embodiments, the platform may be operated by a provider and a different entity may provide the applications or services for users through the platform,

FIG. 3 is a diagram illustrating a system 300 with which an embodiment may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, departments or functions of a company, or organizations, as examples. A user may access the services using a suitable client, including but not limited to desktop computers, laptop computers, tablet computers, scanners, or smartphones.

In general, a client device having access to the Internet may be used to provide data to the platform for processing and evaluation. A user interfaces with the service platform across the Internet 308 or another suitable communications network or combination of networks. Examples of suitable client devices may include (but are not limited to or required to include) desktop computers 303, smartphones 304, tablet computers 305, or laptop computers 306.

System 310 may be hosted by a third party and may include a set of data processing and other services to assist in processing data for use in training a machine learning model or as an input to a trained model 312, and a web interface server 314, coupled as shown in FIG. 3. Either or both the data processing and other services 312 and the web interface server 314 may be implemented on one or more different hardware systems and components, even though represented as singular units in FIG. 3.

Services 312 may include one or more functions or operations for the representation of a set of pre-processing operations for a dataset as a directed acyclic graph (DAG), the separation of the DAG into sub-graphs, rebalancing of data partitions, determination of the execution time and memory requirement for each sub-graph, and the execution/traversal of each sub-graph with the rebalanced data using one or more hardware profiles.

As examples, in some embodiments, the set of functions, operations, processes, or services made available through the platform or system 310 may include:
Account Management services 316, such as:
   a process or service to authenticate a user wishing to utilize services available through access to the SaaS platform;
   a process or service to generate a container or instantiation of the data processing and automated label generation services for that user;
A set of processes or services 318 to:
   Represent the pre-processing of a dataset as a sequence of data conversion and/or transformation operations:
      Each operation in the sequence may be associated with specific dependencies (such as a data format output by one stage and used as an input to a next stage);
         For example, data may be contained in a table with a specific number of rows and columns, or a format for specific fields or values;
   Represent the sequence of data conversions and/or transformations and dependencies as a directed acyclic graph (DAG);
      A DAG may be considered a form of finite state machine where each node represents an allowed state and transitions between states are determined by rules or operations that define edges of the DAG structure (such as the type or category of processor element used);
         Thus, a DAG can be used to represent an ordered sequence of data processing functions or operations that do not result in returning to a previous state;
   Separate the DAG into a set of sub-graphs based on the hardware requirements of a processing step or stage represented by an edge (for example, if it requires a GPU if it is using a deep learning Transformer (NLP) model);
      A process may be used to break a DAG into sub-graphs where the output of one node is input to many nodes (e.g., referred to as “scatter”) and/or input of one node depends on output of many nodes (referred to as “gather”);
      The disclosed and/or described method then identifies nodes representing operations by their hardware requirements (for example, ones that require a GPU, or where the hardware execution requirements of the node changes from CPU to GPU, or vice-versa);
      The DAG is then separated into sub-graphs, with each sub-graph representing a CPU or GPU intensive set of operations (i.e., a set of operations executed by a specific type or category of processor), and the corresponding input and output data from that set of operations;
   Rebalance the partitions in the datasets input to, or output by a set of operations to have the same size after each set of operations (referred to as “dynamic re-partitioning” herein);
      In one embodiment, this re-partitioning is implemented prior to performing the operations associated with a sub-graph, and is executed on the data output by a previous sub-graph;
   Each sub-graph (and its associated functions or operations) may then be associated with a set of one or more pre-execution stages:
      Data sampling (to determine the hardware resource requirements, e.g., CPU/GPU/memory);
         Each processor “indicates” or is associated with a desired hardware profile (CPU, GPU, or FPGA, as examples);
         In one embodiment, a sampling mechanism is used to determine the memory requirement of the operations or functions associated with a sub-graph;
         As an example of addressing heterogeneous computing requirements, take 25-50 rows of the data. Pass this data through the sub-graph (i.e., use it as an input to the data processing stages or operations represented by the sub-graph);
         Start with a baseline memory requirement prior to execution of the sampling process. Then, execute the sampling by passing the sampled data through sub-graph. While doing so, periodically monitor the memory usage of the sampling process, and record the peak memory use;
         At the conclusion of the sampling mechanism, two parameters are known:
         The execution time for the sampled data; and
         The memory used to process the sampled data, as represented by the data processing operations of the sub-graph;
      Next, interpolate/extrapolate the execution time and memory derived from the sampled data to the entire set of data (e.g., the number of rows in the partition associated with the sub-graph). This gives the estimated memory requirement and time to execute the rows in the partition using the operations represented in the sub-graph;
         Dynamically reduce the partition size if the memory requirement is too high to be executed by a single processor or device, or is otherwise undesirable;
      If needed, perform additional data rebalancing—for example, apply dynamic repartitioning to ensure all partitions have the same number of rows (or other relevant characteristic);
   These steps or stages are followed by execution/traversal of a sub-graph with the rebalanced data using one or more hardware profiles, as determined by the hardware configuration requirement for each “stage” or operation of the data processing described by a sub-graph (i.e., processor type and memory requirement). This allows the process flow to:
      Dynamically access needed hardware resources and turn them off (release them) once the processing is complete for a sub-graph. This provides a benefit of cost savings by limiting the use of more expensive (in terms of computational time or memory) resources to when they are needed;
         In contrast, a conventional approach maintains access to resources for the entire execution of the DAG;
      Efficiently interleave different workloads on the same hardware profile;
         In contrast, conventional implementations or approaches can monopolize computational resources for the entire execution time of a sub-graph, thus preventing their most efficient usage and possibly delaying the execution of a portion of a different sub-graph;
Administrative services 320, such as:
   a process or services to provide platform and services administration—for example, to enable the provider of the services and/or the platform to administer and configure the processes and services provided to users.

The platform or system shown in FIG. 3 may be hosted on a distributed computing system made up of at least one, but typically multiple, “servers.” A server is a physical computer dedicated to providing data storage and an execution environment for one or more software applications or services to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server.

FIG. 4 is a diagram illustrating elements or components of an example operating environment 400 with which an embodiment may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components (such as one or more electronic processors, microprocessors, central processing units (CPU), TPUs, GPUs, QPUs, state machines, or controllers). Examples of suitable networks 414 include networks utilizing wired and/or wireless communication technologies and networks operating in accordance with a suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant (or platform administrator) to administer the tenant's access to and use of the functions and capabilities provided by the service platform. This may include accessing tenant data, launching an instantiation of a specific application, or causing the execution of specific data processing operations, as non-limiting examples.

Each application server or processing element 422 shown in the figure may be implemented with a set of computers and/or components including computer servers and processors, and may perform various functions, methods, processes, or operations as determined by the execution of a software application or set of instructions. The data storage tier 424 may include one or more datastores, which may include a Service Datastore 425 and one or more Tenant Datastores 426. Datastores may be implemented with a suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by the execution of one or more modules of software code/instructions by one or more servers 422 that are part of the platform's Application Server Tier 420. As noted with regards to FIG. 3, the platform system shown in FIG. 4 may be hosted on a distributed computing system made up of at least one, but typically multiple, “servers.”

Rather than build and maintain such a platform or system themselves, a business may utilize systems provided by a third party. A third party may implement a system/platform as disclosed and/or described herein in the context of a multi-tenant platform, where individual instantiations of a business' data processing workflow (such as for the processing of training data or input data for a machine learning model) are provided to users, with each user representing a tenant of the platform. One advantage to such multi-tenant platforms is the ability for each tenant to customize their instantiation of the data processing workflow to that tenant's specific needs or operational methods. In some cases, each tenant may be a business or entity that uses the multi-tenant platform to provide services and functionality to multiple users.

FIG. 5 is a diagram illustrating additional details of the elements or components of the multi-tenant distributed computing service platform of FIG. 4, with which an embodiment of the disclosure may be implemented. In general, an embodiment may be implemented using a set of software instructions that are executed by a suitably programmed processing element (such as a CPU, GPU, TPU, QPU, state machine, microprocessor, processor, controller, or computing device as examples). In a complex system such instructions are typically arranged into “modules” with each module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform. The example architecture includes a user interface (UI) layer or tier 502 having one or more user interfaces 503. Examples of such user interfaces include graphical user interfaces and application programming interfaces (APIs). Each user interface may include one or more interface elements 504. Users may interact with interface elements to access functionality and/or data provided by application and/or data storage layers of the example architecture.

Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing data processing and services to a user of the platform). Such function, method, process, or operation may include those used to implement one or more aspects of the disclosed and/or described system and methods, such as for one or more of the processes or functions described with reference to the Figures and/or disclosed or described in the specification:
Represent the pre-processing of a dataset as a sequence of data conversion and/or transformation operations:
   In some embodiments, this may include separating a data pre-processing flow into a sequence of defined operations or functions;
   Each operation in the sequence may be associated with specific dependencies (such as a data format output by one stage and used as an input to a next stage);
      For example, data may be contained in a table with a specific number of rows and columns, or a format for specific fields or values;
Represent the sequence of data conversions and/or transformations and dependencies as a directed acyclic graph (DAG);
Separate the DAG into a set of sub-graphs based on the hardware requirements of a processing step or stage represented by an edge (for example, if it uses a GPU for a deep learning model);
   The DAG or one or more of the identified sub-graphs may be further separated into sub-graphs, with each sub-graph representing a CPU or GPU intensive set of operations (i.e., a set of operations executed by a specific type or category of processor), and the corresponding input and output data from that set of operations;
   If other forms of processing components are used, perform the same separation process to identify sub-graphs representing an operation or operations performed by that processing component;
   In one embodiment, a process may be used to break a DAG into a set of sub-graphs, such as where the output of one node is input to many nodes (e.g., referred to as “scatter”) and/or the input of one node depends on output of many nodes (referred to as “gather”);
Rebalance (modify) the partitions in the datasets input to, or output by a set of operations to have the same size after each set of operations (referred to as “dynamic re-partitioning” herein);
   In one embodiment, this re-partitioning is implemented prior to performing the operations associated with a sub-graph, and is executed on the data output by a previous sub-graph;
   As a non-limiting example, this may involve causing data sets input or output by a set of operations (i.e., input to a sub-graph or output from a previous sub-graph) to have the same size (i.e., the same number of rows and columns in a table, as an example) after each set of operations;
Each sub-graph (and its associated functions or operations) may then be associated with a set of one or more pre-execution stages. In one embodiment, these pre-execution stages may include one or more of:
   Data sampling (to determine the hardware resource requirements, e.g., CPU or GPU and memory);
      Each processor “indicates” or is associated with a desired hardware profile (CPU, GPU, or FPGA, as examples);
      In one embodiment, a sampling mechanism is used to determine the memory requirement for the operations or functions associated with a sub-graph;
      At the conclusion of the sampling mechanism, two parameters are known:
         The execution time for the sampled data; and
         The (peak) memory used to process the sampled data, as represented by the data processing operations of the sub-graph;
   Next, interpolate/extrapolate the execution time and memory derived from the sampled data to the entire set of data (e.g., the number of rows in the partition associated with the sub-graph). This gives the estimated memory requirement and time to execute the rows in the partition using the operations represented in the sub-graph;
   This may include dynamically reducing the partition size if the memory requirement is too high to be executed by a single processor or device, or is otherwise undesirable;
   If needed, perform additional data rebalancing—for example, apply dynamic repartitioning to ensure all partitions have the same number of rows (or other relevant characteristic;
These steps or stages are followed by execution/traversal of the sub-graph with the rebalanced data using one or more hardware profiles, as determined by the hardware configuration requirement for each “stage”, function, or operation of the data processing described by a sub-graph (i.e., the interpolated values for the processor type, computation time, and memory requirement).

The application modules and/or sub-modules may include a suitable computer-executable code or set of instructions (e.g., as would be executed by a suitably programmed processor, microprocessor, GPU, TPU, QPU, state machine, or CPU, as examples), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each datastore in the data storage layer may include each data object. Alternatively, different datastores may include different sets of data objects. Such sets may be disjoint or overlapping.

Note that the computing environments illustrated in FIGS. 3, 4, and 5 are not intended to be limiting examples. Further environments in which an embodiment may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The disclosure includes the following clauses and embodiments:

1. A method of pre-processing a set of data for use in training a model or for use as an input to a trained model, comprising:
representing the pre-processing of a dataset as a sequence of one or more data conversion and data transformation operations;
representing the sequence of one or more data conversions and data transformations and associated dependencies as a directed acyclic graph (DAG), wherein the nodes of the directed acyclic graph represent a state of the processing of the set of data, and an edge connecting two nodes represents a type of processor used to perform a data conversion or transformation;
separating the directed acyclic graph into a set of sub-graphs, wherein each sub-graph represents one or more operations executed by a specific type or class of processor;
rebalancing one or more partitions in the data input to, or output by an operation to have substantially the same size after each operation executed by a specific type or class of processor;
associating each sub-graph with an execution time and memory used to process the data input to a sub-graph using the one or more operations represented by the sub-graph; and
for each sub-graph, executing the one or operations associated with a sub-graph with the rebalanced partitions of the datasets using the specific type of or class of processor.

2. The method of clause 1, wherein the one or more data conversion and data transformation operations comprise executing an optical character recognition model on a PDF document to extract text content, sanitizing raw text fields to remove unexpected characters, or executing a machine learning model on text data to compute an embedding representation.

3. The method of clause 1, wherein each operation in the sequence of one or more data conversion and data transformation operations is associated with one or more specific dependencies that define a data format or structure for an input or an output of a data conversion or data transformation operation.

4. The method of clause 1, wherein the specific type or class of processor comprises a CPU, a GPU, a DSP, a FPGA, or an ASIC.

5. The method of clause 1, wherein rebalancing one or more partitions in the data input to, or output by an operation to have substantially the same size after each operation executed by a specific type or class of processor further comprises adjusting the number of rows and columns in a table to be substantially the same in the data input to and output from the operation.

6. The method of clause 1, wherein associating each sub-graph with an execution time and memory used to process the data input to a sub-graph using the one or more operations represented by the sub-graph further comprises using a sampling mechanism to determine the memory requirement of the operations or functions associated with a sub-graph, and further wherein the sampling mechanism provides an execution time for the sampled data and a value for the peak memory used to process the sampled data.

7. The method of clause 6, further comprising interpolating or extrapolating the execution time and the value for the peak memory to an entire set of data used as an input to the sub-graph.

8. The method of clause 7, wherein for each sub-graph, executing the one or operations associated with a sub-graph with the rebalanced partitions of the datasets using the specific type of or class of processor associated with the sub-graph comprises using the interpolated or extrapolated execution time and the value for the peak memory with the specific type or class of processor.

9. The method of clause 1, further comprising dynamically reducing a partition size if the memory requirement for the data in the partition is exceeds that to be executed by a single processor or device.

10. The method of clause 1, wherein executing the operations associate with a sub-graph further comprises associating a sub-graph with a different hardware profile if the execution time can be improved.

11. A system for pre-processing a set of data for use in training a model or for use as an input to a trained model, comprising:
one or more electronic processors configured to execute a set of computer-executable instructions; and
one or more non-transitory computer-readable media containing the set of computer-executable instructions, wherein when executed, the instructions cause the one or more electronic processors or an apparatus or device in which they are contained to
   represent the pre-processing of a dataset as a sequence of one or more data conversion and data transformation operations;
   represent the sequence of one or more data conversions and data transformations and associated dependencies as a directed acyclic graph (DAG), wherein the nodes of the directed acyclic graph represent a state of the processing of the set of data, and an edge connecting two nodes represents a type of processor used to perform a data conversion or transformation;
   separate the directed acyclic graph into a set of sub-graphs, wherein each sub-graph represents one or more operations executed by a specific type or class of processor;
   rebalance one or more partitions in the data input to, or output by an operation to have substantially the same size after each operation executed by a specific type or class of processor;
   associate each sub-graph with an execution time and memory used to process the data input to a sub-graph using the one or more operations represented by the sub-graph; and
   for each sub-graph, execute the one or operations associated with a sub-graph with the rebalanced partitions of the datasets using the specific type of or class of processor.

12. One or more non-transitory computer-readable media comprising a set of computer-executable instructions that when executed by one or more programmed electronic processors, cause the processors or an apparatus or device in which they are contained to:
represent the pre-processing of a dataset as a sequence of one or more data conversion and data transformation operations;
represent the sequence of one or more data conversions and data transformations and associated dependencies as a directed acyclic graph (DAG), wherein the nodes of the directed acyclic graph represent a state of the processing of the set of data, and an edge connecting two nodes represents a type of processor used to perform a data conversion or transformation;
separate the directed acyclic graph into a set of sub-graphs, wherein each sub-graph represents one or more operations executed by a specific type or class of processor;
rebalance one or more partitions in the data input to, or output by an operation to have substantially the same size after each operation executed by a specific type or class of processor;
associate each sub-graph with an execution time and memory used to process the data input to a sub-graph using the one or more operations represented by the sub-graph; and
for each sub-graph, execute the one or operations associated with a sub-graph with the rebalanced partitions of the datasets using the specific type of or class of processor.

The disclosed system and methods can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

In some embodiments, certain of the methods, models, processes, or functions disclosed and/or described herein may be embodied in the form of a trained neural network or other form of model derived from a machine learning algorithm. The neural network or model may be implemented by the execution of a set of computer-executable instructions and/or represented as a data structure. The instructions may be stored in (or on) a non-transitory computer-readable medium and executed by a programmed processor or processing element. A neural network or deep learning model may be characterized in the form of a data structure in which are stored data representing a set of layers, with each layer containing a set of nodes, and with connections (and associated weights) between nodes in different layers. The neural network or model operates on an input to provide a decision, prediction, inference, or value as an output.

The set of instructions may be conveyed to a user through a transfer of instructions or an application that executes a set of instructions over a network (e.g., the Internet). The set of instructions or an application may be utilized by an end-user through access to a SaaS platform, self-hosted software, on-premise software, or a service provided through a remote platform.

In general terms, a neural network may be viewed as a system of interconnected artificial “neurons” or nodes that exchange messages between each other. The connections have numeric weights that are “tuned” during a training process, so that a properly trained network will respond correctly when presented with an image, pattern, or set of data. In this characterization, the network consists of multiple layers of feature-detecting “neurons”, where each layer has neurons that respond to different combinations of inputs from the previous layers.

Training of a network (if needed) is performed using a “labelled” data set of inputs in an assortment of representative input patterns (or data sets) that are associated with their intended output response. Training uses general-purpose methods to iteratively determine the weights for intermediate and final feature neurons. In terms of a computational model, each neuron calculates the dot product of inputs and weights, adds a bias, and applies a non-linear trigger or activation function (for example, using a sigmoid response function).

Machine learning (ML) is used to analyze data and assist in making decisions in multiple industries. To benefit from using machine learning, a machine learning algorithm is applied to a set of training data and labels to generate a “model” which represents what the application of the algorithm has “learned” from the training data. Each element (or example) in the form of one or more parameters, variables, characteristics, or “features” of the set of training data is associated with a label or annotation that defines how the element should be classified by the trained model. A machine learning model can predict or infer an outcome based on the training data and labels and be used as part of decision process. When trained, the model will operate on a new element of input data to generate the correct label or classification as an output.

The software components, processes or functions described in this application may be implemented as software code to be executed by a processor using any suitable computer language such as Python, Java, Javascript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as a display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or a similar device or other form of memory based on a similar technology. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It should be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not need to be performed in the order presented or may not need to be performed at all.

The computer-executable program instructions may be loaded onto a general-purpose computer, a special purpose computer, a processor, or other programmable data processing apparatus to produce a specific example of a machine, where the instructions executed by the computer, processor, or other programmable data processing apparatus create means for implementing one or more of the functions, operations, processes, or methods disclosed and/or described herein. These computer program instructions may be stored in (or on) a computer-readable memory that can direct a computer or other programmable data processing apparatus to function in a specific manner, such that the instructions stored in (or on) the computer-readable memory produce an article of manufacture including instruction means that implement one or more of the functions, operations, processes, or methods disclosed and/or described herein.

While certain implementations of the disclosed technology have been described in connection with what is presently considered to be the most practical implementation, it should be understood that the disclosed technology is not limited to those implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed and/or described technology, and to enable a person skilled in the art to practice one or more embodiments, including making and using devices or systems, and performing the incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar references in the specification and in the following claims are to be construed to cover both the singular and the plural, unless otherwise indicated herein or clearly contradicted by context. The terms “having,” “including,” “containing” and similar references in the specification and in the following claims are to be construed as open-ended terms (e.g., meaning “including, but not limited to,”) unless otherwise noted.

Recitation of ranges of values herein are intended to serve as a shorthand method of referring individually to each separate value inclusively falling within the range, unless otherwise indicated herein, and each separate value is incorporated into the specification as if it were individually recited herein. Methods disclosed and/or described herein can be performed in any suitable order unless otherwise indicated herein or clearly contradicted by context. The use of any and all examples, or exemplary language (e.g., “such as”) is intended to better illuminate embodiments of the disclosure and does not pose a limitation to the scope of the disclosure unless otherwise claimed. No language in the specification should be construed as indicating a non-claimed element as essential to each embodiment of the disclosure.

As used herein (i.e., the claims, figures, and specification), the term “or” is used inclusively to refer to items in the alternative and in combination.

Different arrangements of the components depicted in the drawings or described herein, as well as components and steps not shown or described are possible. Similarly, some features and sub-combinations are useful and may be employed without reference to other features and sub-combinations. Embodiments have been described for illustrative and not restrictive purposes, and alternative embodiments may become apparent to readers of this disclosure. Accordingly, the embodiments are not limited to the embodiments described herein or depicted in the drawings, and various embodiments and modifications can be made without departing from the scope of the claims below.

That which is claimed is:

1. A method of pre-processing a set of data for use in training a model or for use as an input to a trained model, comprising:
representing the pre-processing of a dataset as a sequence of one or more data conversion and data transformation operations;
representing the sequence of one or more data conversions and data transformations and associated dependencies as a directed acyclic graph (DAG), wherein the nodes of the directed acyclic graph represent a state of the processing of the set of data, and an edge connecting two nodes represents a type of processor used to perform a data conversion or transformation;
separating the directed acyclic graph into a set of sub-graphs, wherein each sub-graph represents one or more operations executed by a specific type or class of processor;
rebalancing one or more partitions in the data input to, or output by an operation to have substantially the same size after each operation executed by a specific type or class of processor;
associating each sub-graph with an execution time and memory used to process the data input to a sub-graph using the one or more operations represented by the sub-graph; and
for each sub-graph, executing the one or operations associated with a sub-graph with the rebalanced partitions of the datasets using the specific type of or class of processor.

2. The method of claim 1, wherein the one or more data conversion and data transformation operations comprise executing an optical character recognition model on a PDF document to extract text content, sanitizing raw text fields to remove unexpected characters, or executing a machine learning model on text data to compute an embedding representation.

3. The method of claim 1, wherein each operation in the sequence of one or more data conversion and data transformation operations is associated with one or more specific dependencies that define a data format or structure for an input or an output of a data conversion or data transformation operation.

4. The method of claim 1, wherein the specific type or class of processor comprises a CPU, a GPU, a DSP, a FPGA, or an ASIC.

5. The method of claim 1, wherein rebalancing one or more partitions in the data input to, or output by an operation to have substantially the same size after each operation executed by a specific type or class of processor further comprises adjusting the number of rows and columns in a table to be substantially the same in the data input to and output from the operation.

6. The method of claim 1, wherein associating each sub-graph with an execution time and memory used to process the data input to a sub-graph using the one or more operations represented by the sub-graph further comprises using a sampling mechanism to determine the memory requirement of the operations or functions associated with a sub-graph, and further wherein the sampling mechanism provides an execution time for the sampled data and a value for the peak memory used to process the sampled data.

7. The method of claim 6, further comprising interpolating or extrapolating the execution time and the value for the peak memory to an entire set of data used as an input to the sub-graph.

8. The method of claim 7, wherein for each sub-graph, executing the one or operations associated with a sub-graph with the rebalanced partitions of the datasets using the specific type of or class of processor associated with the sub-graph comprises using the interpolated or extrapolated execution time and the value for the peak memory with the specific type or class of processor.

9. The method of claim 1, further comprising dynamically reducing a partition size if the memory requirement for the data in the partition is exceeds that to be executed by a single processor or device.

10. The method of claim 1, wherein executing the operations associate with a sub-graph further comprises associating a sub-graph with a different hardware profile if the execution time can be improved.

11. A system for pre-processing a set of data for use in training a model or for use as an input to a trained model, comprising:
one or more electronic processors configured to execute a set of computer-executable instructions; and
one or more non-transitory computer-readable media containing the set of computer-executable instructions, wherein when executed, the instructions cause the one or more electronic processors or an apparatus or device in which they are contained to
represent the pre-processing of a dataset as a sequence of one or more data conversion and data transformation operations;
represent the sequence of one or more data conversions and data transformations and associated dependencies as a directed acyclic graph (DAG), wherein the nodes of the directed acyclic graph represent a state of the processing of the set of data, and an edge connecting two nodes represents a type of processor used to perform a data conversion or transformation;
separate the directed acyclic graph into a set of sub-graphs, wherein each sub-graph represents one or more operations executed by a specific type or class of processor;
rebalance one or more partitions in the data input to, or output by an operation to have substantially the same size after each operation executed by a specific type or class of processor;
associate each sub-graph with an execution time and memory used to process the data input to a sub-graph using the one or more operations represented by the sub-graph; and
for each sub-graph, execute the one or operations associated with a sub-graph with the rebalanced partitions of the datasets using the specific type of or class of processor.

12. The system of claim 11, wherein the one or more data conversion and data transformation operations comprise executing an optical character recognition model on a PDF document to extract text content, sanitizing raw text fields to remove unexpected characters, or executing a machine learning model on text data to compute an embedding representation.

13. The system of claim 11, wherein each operation in the sequence of one or more data conversion and data transformation operations is associated with one or more specific dependencies that define a data format or structure for an input or an output of a data conversion or data transformation operation.

14. The system of claim 11, wherein associating each sub-graph with an execution time and memory used to process the data input to a sub-graph using the one or more operations represented by the sub-graph further comprises using a sampling mechanism to determine the memory requirement of the operations or functions associated with a sub-graph, and further wherein the sampling mechanism provides an execution time for the sampled data and a value for the peak memory used to process the sampled data.

15. The system of claim 14, further comprising interpolating or extrapolating the execution time and the value for the peak memory to an entire set of data used as an input to the sub-graph, and wherein for each sub-graph, executing the one or operations associated with a sub-graph with the rebalanced partitions of the datasets using the specific type of or class of processor associated with the sub-graph comprises using the interpolated or extrapolated execution time and the value for the peak memory with the specific type or class of processor.

16. One or more non-transitory computer-readable media comprising a set of computer-executable instructions that when executed by one or more programmed electronic processors, cause the processors or an apparatus or device in which they are contained to:
represent the pre-processing of a dataset as a sequence of one or more data conversion and data transformation operations;
represent the sequence of one or more data conversions and data transformations and associated dependencies as a directed acyclic graph (DAG), wherein the nodes of the directed acyclic graph represent a state of the processing of the set of data, and an edge connecting two nodes represents a type of processor used to perform a data conversion or transformation;
separate the directed acyclic graph into a set of sub-graphs, wherein each sub-graph represents one or more operations executed by a specific type or class of processor;
rebalance one or more partitions in the data input to, or output by an operation to have substantially the same size after each operation executed by a specific type or class of processor;
associate each sub-graph with an execution time and memory used to process the data input to a sub-graph using the one or more operations represented by the sub-graph; and
for each sub-graph, execute the one or operations associated with a sub-graph with the rebalanced partitions of the datasets using the specific type of or class of processor.

17. The one or more non-transitory computer-readable media of claim 16, wherein the one or more data conversion and data transformation operations comprise executing an optical character recognition model on a PDF document to extract text content, sanitizing raw text fields to remove unexpected characters, or executing a machine learning model on text data to compute an embedding representation.

18. The one or more non-transitory computer-readable media of claim 16, wherein each operation in the sequence of one or more data conversion and data transformation operations is associated with one or more specific dependencies that define a data format or structure for an input or an output of a data conversion or data transformation operation.

19. The one or more non-transitory computer-readable media of claim 16, wherein associating each sub-graph with an execution time and memory used to process the data input to a sub-graph using the one or more operations represented by the sub-graph further comprises using a sampling mechanism to determine the memory requirement of the operations or functions associated with a sub-graph, and further wherein the sampling mechanism provides an execution time for the sampled data and a value for the peak memory used to process the sampled data.

20. The one or more non-transitory computer-readable media of claim 19, further comprising interpolating or extrapolating the execution time and the value for the peak memory to an entire set of data used as an input to the sub-graph, and wherein for each sub-graph, executing the one or operations associated with a sub-graph with the rebalanced partitions of the datasets using the specific type of or class of processor associated with the sub-graph comprises using the interpolated or extrapolated execution time and the value for the peak memory with the specific type or class of processor.
